(19) United States
(12) Patent Application Publication
(10) Pub. No.: US 2006/0075494 A1
(43) Pub. Date: Apr. 6, 2006

(54) Method and system for analyzing data for potential malware

(76) Inventors: Justin R. Bertman, Erie, CO (US); Matthew L. Boney, Longmont, CO (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 11/079,417

(22) Filed: Mar. 14, 2005

Related U.S. Application Data
(63) Continuation-in-part of application No. 10/956,578, filed on Oct. 1, 2004.
(63) Continuation-in-part of application No. 10/956,573, filed on Oct. 1, 2004.
(63) Continuation-in-part of application No. 10/956,274, filed on Oct. 1, 2004.
(63) Continuation-in-part of application No. 10/956,574, filed on Oct. 1, 2004.
(63) Continuation-in-part of application No. 10/956,818, filed on Oct. 1, 2004.
(63) Continuation-in-part of application No. 10/956,575, filed on Oct. 1, 2004.

(51) Int. Cl. G06F 12/14

(52) U.S. Cl. 726/22

(57) ABSTRACT

A system and method for generating a definition for malware and/or detecting malware. is described. One exemplary embodiment includes a downloader for downloading a portion of a Web site; a parser for parsing the downloaded portion of the Web site; a statistical analysis engine for determining if the downloaded portions of the Web site should be evaluated by the active browser; an active browser for identifying changes to the known configuration of the active browser, wherein the changes are caused by the downloaded portion of the Web site; and a definition module for generating a definition for the potential malware based on the changes to the known configuration.

### PRIORITY

The present application is a continuation in part of the commonly owned and assigned application Ser. No. 10/956,578, System And Method For Monitoring Network Communications For Pestware; Ser. No. 10/956,573, System And Method For Heuristic Analysis To Identify Pestware; Ser. No. 10/956,274, System And Method For Locating Malware; Ser. No. 10/956,574, System And Method For Pestware Detection And Removal; Ser. No. 10/956,818, System And Method For Locating Malware And Generating Malware Definitions; and Ser. No. 10/956,575, System And Method For Actively Operating Malware To Generate A Definition, all of which are incorporated herein by reference.

### FIELD OF THE INVENTION

The present invention relates to computer system management. In particular, but not by way of limitation, the present invention relates to systems and methods for detecting, controlling and/or removing malware.

### BACKGROUND OF THE INVENTION

Personal computers and business computers are continually attacked by trojans, spyware, and adware—collectively referred to as “malware” or “pestware,” for the purposes of this application. These types of programs generally act to gather information about a person or organization—often without the person or organization's knowledge. Some malware is highly malicious. Other malware is non-malicious but may cause issues with privacy or system performance. And yet other malware is actual beneficial or wanted by the user. Wanted malware is sometimes not characterized as “malware,” “pestware,” or “spyware.” But, unless specified otherwise, “pestware” and “malware,” as used herein, refer to any program that collects information about a person or an organization or otherwise monitors a user, a user's activities, or a user's computer.

Software is available to detect and remove malware. But as malware evolves, the software to detect and remove it must also evolve. Accordingly, current techniques and software are not always satisfactory and will most certainly not be satisfactory in the future. Additionally, because some malware is actually valuable to a user, malware-detection software should, in some cases, be able to handle differences between wanted and unwanted malware.

Current malware removal software uses definitions of known malware to search for and remove files on a protected system. These definitions are often slow and cumbersome to create. Additionally, it is often difficult to initially locate the malware in order to create the definitions. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for generating a definition for malware and/or detecting malware. One exemplary embodiment includes a downloader for downloading a portion of a Web site; a parser for parsing the downloaded portion of the Web site; a statistical analysis engine for determining if the downloaded portions of the Web site should be evaluated by the active browser; an active browser for identifying changes to the known configuration of the active browser, wherein the changes are caused by the downloaded portion of the Web site; and a definition module for generating a definition for the potential malware based on the changes to the known configuration. Other components can be included in other embodiments and some of these components are not included in other embodiments.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram of one embodiment of the present invention;

FIG. 2 is a flowchart of one method for evaluating a URL's connection to malware;

FIG. 3 is a flowchart of one method for parsing forms and JavaScript (and similar script languages) to identify malware;

FIG. 4 is a flowchart of one method for actively browsing a Web site to identify potential malware;

FIG. 5 is a block diagram of one implementation of the present invention;

FIG. 6 is a block diagram of one implementation of a monitoring system;

FIG. 7 is a block diagram of another embodiment of a monitoring system;

FIG. 8 illustrates another embodiment of the present invention;

FIG. 9 is a flowchart of one method for screening Web pages as they are downloaded to a browser;

FIG. 10 is a block diagram illustrating one method of using a statistical analysis in conjunction with malware detection programs; and

FIG. 11 illustrates another method for managing malware that is resistant to permanent removal or that cannot be identified for removal.

### DETAILED DESCRIPTION

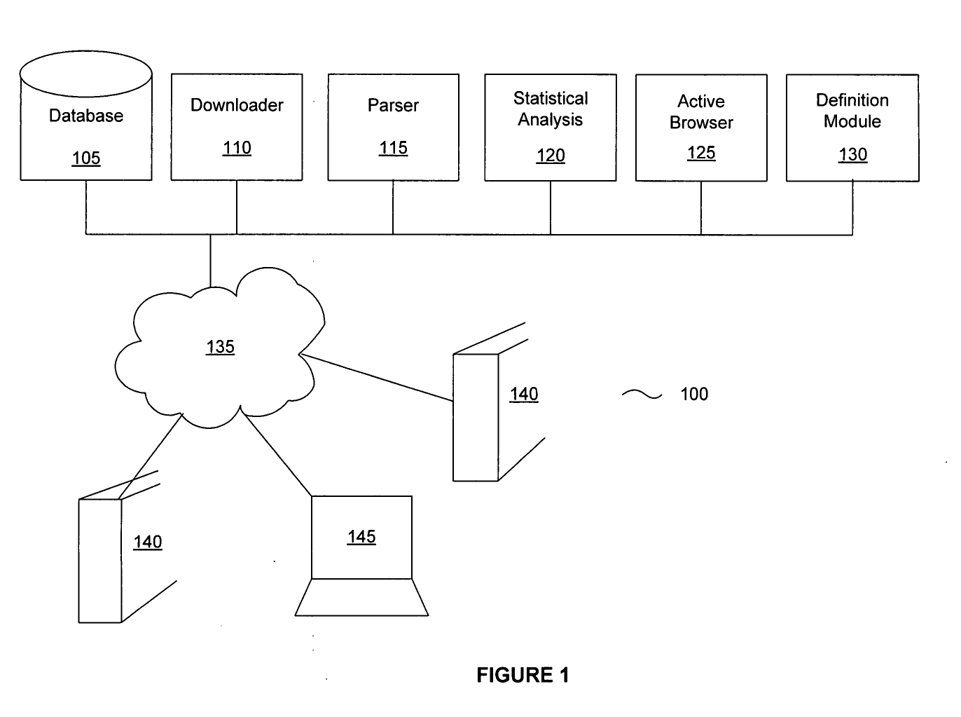

Referring now to the drawings, where like or similar elements are designated with identical reference numerals throughout the several views, and referring in particular to FIG. 1, it is a block diagram of one embodiment 100 of the present invention. This embodiment includes a database 105, a downloader 110, a parser 115, a statistical analysis engine 120, an active browser 125, and a definition module 130. These components, which are described below, can be connected through a network 135 to Web servers 140 and protected computers 145. These components are described briefly with regard to FIG. 1, and their operation is further described in the description accompanying the other figures.

The database 105 of FIG. 1 can be built on an ORACLE platform or any other database platform and can include several tables or be divided into separate database systems. But assuming that the database 105 is a single database with multiple tables, the tables can be generally categorized as URLs to search, downloaded HTML, downloaded targets, and definitions. (As used herein, “targets” refers to any program, program trace, file, object, exploit, malware activity, or URL that corresponds to malware.)

The URL table stores a list of URLs that should be searched or evaluated for malware. The URL table can be populated by crawling the Internet and storing any found links. The system 100 can then download material from these links for subsequent evaluation.

Embodiments of the present invention expand and/or modify the traditional techniques used to located URLs. In particular, some embodiments of the present invention search for hidden URLs. For example, malware distributors often try to hide their URLs rather than have them pushed out to the public. Traditional search-engine techniques look for high-traffic URLs—such as CNN.COM—but often miss deliberately-hidden URLs. Embodiments of the present invention seek out these hidden URLs, which likely link to malware.

The URL list can easily grow to millions of entries, and all of these entries cannot be searched simultaneous. Accordingly, a ranking system is used to determine which URLs to evaluate and when to evaluate them. In one embodiment, the URLs stored in the database 105 can be stored in association with corresponding data such as a time stamp identifying the last time the URL was accessed, a priority level indicating when to access the URL again, etc. For example, the priority level corresponding to CNN.COM would likely be low because the likelihood of finding malware on a trusted site like CNN.COM is low. On the other hand, the likelihood of finding malware on a pornography-related site is much higher, so the priority level for the pornography-related URL could be set to a high level. These differing priority levels could, for example, cause the CNN.COM site to be evaluated for malware once a month and the pornography-related site to be evaluated once a week.

Another table in the database 105 can store HTML code or pointers to the HTML code downloaded from an evaluated URL. This downloaded HTML code can be used for statistical purposes and/or for analysis purposes. For example, a hash value can be calculated and stored in association with the HTML code corresponding to a particular URL. When the same URL is accessed again, the HTML code can be downloaded again and the new hash value calculated. If the hash value for both downloads is the same, then the content at that URL has not changed and further processing is not necessarily required.

Two other tables in the database 105 relate to identified malware or potential malware. (Collectively referred to as a “target.”) That is, these tables store information about known or suspected malware. One table can store the code, including script and HTML, and/or the URL associated with any identified target. And the other table can store the definitions related to the targets. These definitions, which are discussed in more detail below, can include a list of the activities caused by the target, a hash function of the actual malware code, the actual malware code, etc. Notably, computer owners can identify malware on their own computers using these definitions. This process is described below in detail.

Referring now to the downloader 110 in FIG. 1, it retrieves the code, including script and HTML, associated with a particular URL. For example, the downloader 110 selects a URL from the database 105 and identifies the IP address corresponding to the URL. The downloader 110 then forms and sends a request to the IP address corresponding to the URL. The downloader 110, for example, then downloads HTML, JavaScript, applets, and/or objects corresponding to the URL. Although this document often discusses HTML, JavaScript, and Java applets, those of skill in the art can understand that embodiments of the present invention can operate on any object within a Web page, including other types of markup languages, other types of script languages, any applet programs such as ACTIVEX from MICROSOFT, and any other downloaded objects. When these specific terms are used, they should be understood to also include generic versions and other vendor versions.

Still referring to FIG. 1, once the requested information from the URL is received by the downloader 110, the downloader 10 can send it to the database 105 for storage. In certain embodiments, the downloader 110 can open multiple sockets to handle multiple data paths for faster downloading.

Referring now to the parser 115 shown in FIG. 1, it is responsible for searching downloaded material for malware and possible pointers to other malware. Generally, the parser is searching for known malware, known potential malware, and triggers that indicate a high likelihood of malware. And when the parser 115 discovers any of these issues, the relevant information is provided to the active browser 125 for verification of whether or not it is actually malware.

This embodiment of the parser 115 includes three individual parsers: an HTML parser, a JavaScript parser, and a form parser. The HTML parser is responsible for crawling HTML code corresponding to a URL and locating embedded URLs. The JavaScript parser parses JavaScript, or any script language, embedded in downloaded Web pages to identify embedded URLs and other potential malware. And the form parser identifies forms and fields in downloaded material that require user input for further navigation.

Referring first to the URL parser, it can operate much as a typical Web crawler and traverse links in a Web page. It is generally handed a top level link and instructed to crawl starting at that top level link. Any discovered URLs can be added to the URL table in the database 105.

The URL parser can also store a priority indication with any URL. The priority indication can indicate the likelihood that the URL will point to content or other URLs that include malware. For example, the priority indication could be based on whether malware was previously found using this URL. In other embodiments, the priority indication is based on whether a URL included links to other malware sites. And in other embodiments, the priority indication can indicate how often the URL should be searched. Trusted sites such as CNN.COM, for example, do not need to be searched regularly for malware. And in yet another embodiment, a statistical analysis—such as a Bayesian analysis—can be performed on the material associated with the URL. This statistical analysis can indicate the likelihood that malware is present and can be used to supplement the priority indication. Portions of this statistical analysis process are discussed with relation to the statistical analysis engine.

As for the JavaScript parser, it parses (decodes) JavaScript, or other scripts, embedded in downloaded Web pages so that embedded URLs and other potential malware can be more easily identified. For example, the JavaScript parser can decode obfuscation techniques used by malware programmers to hide their malware from identification. The presence of obfuscation techniques may related directly to the evaluation priority assigned to a particular URL.

In one embodiment, the JavaScript parser uses a JavaScript interpreter such as the MOZILLA browser to identify embedded URLs or hidden malware. For example, the JavaScript interpreter could decode URL addresses that are obfuscated in the JavaScript through the use of ASCII characters or hexadecimal encoding. Similarly, the JavaScript interpreter could decode actual JavaScript programs that have been obfuscated. In essence, the JavaScript interpreter is undoing the tricks used by malware programmers to hide their malware. And once the tricks have been removed, the interpreted code can be searched for text strings and URLs related to malware.

Obfuscation techniques, such as using hexadecimal or ASCII codes to represent text strings, generally indicate the presence of malware. Accordingly, obfuscated URLs can be added to the URL database and indicated as a high priority URL for subsequent crawling. These URLs could also be passed to the active browser immediately so that a malware definition can be generated if necessary. Similarly, other obfuscated JavaScript can be passed to the active browser 125 as potential malware or otherwise flagged.

Still referring to the parser 115 in FIG. 1, it also includes a form parser. The form parser identifies forms and fields in downloaded material that require user input for further navigation. For some forms and fields, the form parser can follow the branches embedded in the JavaScript. For other forms and fields, the parser passes the URL associated with the forms or field to the active browser 125 for complete navigation or to the statistical analysis engine 120 for further analysis.

The form parser's main goal is to identify anything that could be or could contain malware. This includes, but is not limited to, finding submit forms, button click events, and evaluation statements that could lead to malware being installed on the host machine. Anything that is not able to be verified by the form parser can be sent to the active browser 125 for further inspection. For example, button click events that run a function rather than submitting information could be sent to the active browser 125. Similarly, if a field is checked by server side JavaScript and requires formatted input, like a phone number that requires parenthesis around the area code, then this type of form could be sent to the active browser 125.

Referring now to the statistical analysis engine 120, it is responsible for determining the probability that any particular Web page or URL is associated with malware. For example, the statistical analysis engine 120 can use Bayesian analysis to score a Web site. The statistical analysis engine 120 can then use that score to determine whether a Web page or portions of a Web page should be passed to the active browser 125. Thus, in this embodiment, the statistical analysis engine 120 acts to limit the number of Web pages passed to the active browser 125.

The statistical analysis engine 120, in this implementation, learns from good Web pages and bad Web pages. That is, the statistical analysis engine 120 builds a list of malware characteristics and good Web page characteristics and improves that list with every new Web page that it analyzes. The statistical analysis engine 120 can learn from the HTML text, headers, images, IP addresses, phrases, format, code type, etc. And all of this information can be used to generate a score for each Web page.

Web pages that include known or potential malware and pages that the statistical analysis engine 120 scores high are passed to the active browser 125. The active browser 125 is designed to automatically navigate Web page(s). In essence, the active browser 125 surfs a Web page or Web site as a person would. The active browser 125 generally follows each possible path on the Web page and if necessary, populates any forms, fields, or check boxes to fully navigate the site.

The active browser 125 generally operates on a clean computer system with a known configuration. For example, the active browser 125 could operate on a WINDOWS-based system that operates INTERNET EXPLORER. It could also operate on a Linux-based system operating a MOZILLA browser.

As the active browser 125 navigates a Web site, any changes to the configuration of the active browser's computer system are recorded. “Changes” refers to any type of change to the computer system including, changes to a operating system file, addition or removal of files, changing file names, changing the browser configuration, opening communication ports, communication attempts, etc. For example, a configuration change could include a change to the WINDOWS registry file or any similar file for other operating systems. For clarity, the term “registry file” refers to the WINDOWS registry file and any similar type of file, whether for earlier WINDOWS versions or other operating systems, including Linux.

And finally, the definition module 130 shown in FIG. 1 is responsible for generating malware definitions that are stored in the database 105 and, in some embodiments, pushed to the protected computers 145. The definition module 130 can determine which of the changes recorded by the active browser 125 are associated with malware and which are associated with acceptable activities.

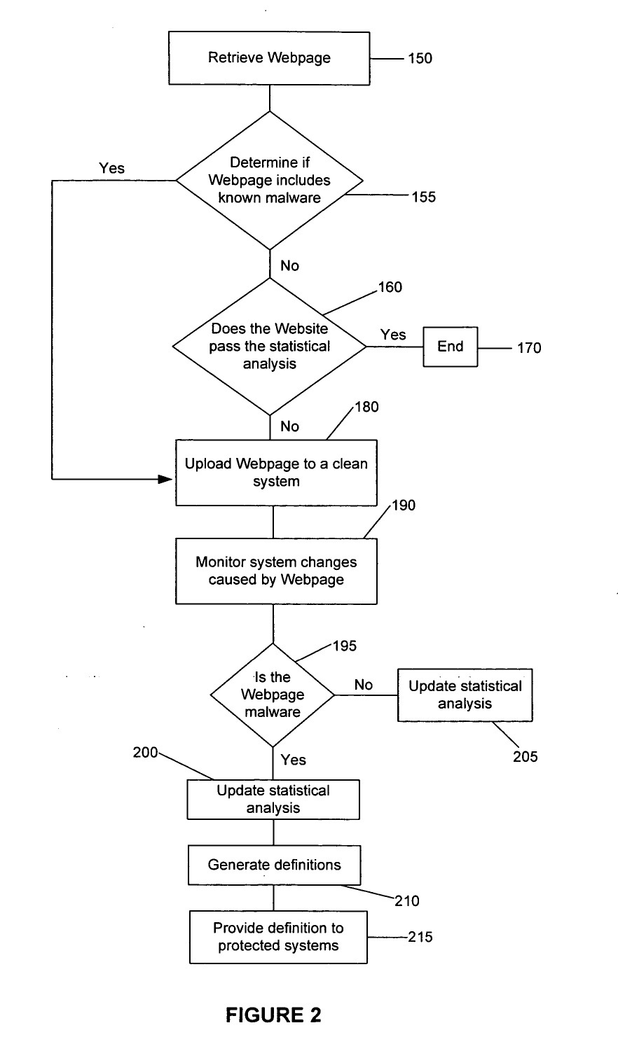

Referring now to FIG. 2, it is a flowchart of one method for evaluating a URL's connection to malware. This method is described with relation to the system of FIG. 1, but those of skill in the art will recognize that the method can be implemented on other systems.

Initially, the downloader 110 retrieves or otherwise obtains a URL from the database 105. Typically, the downloader 110 retrieves a high-priority URL or a batch of high-priority URLs. The downloader 110 then retrieves the material associated with the URL. (Block 150) Before further processing the downloaded material, the downloader 110 can compare the material against previously downloaded material from the same URL. For example, the downloader 110 could calculate a cyclic redundancy code (CRC), or some other hash function value, for the downloaded material and compare it against the CRC for the previously downloaded material. If the CRCs match, then the newly downloaded material can be discarded without further processing. But if the two CRCs do not match, then the newly downloaded material is different and should be passed on for further processing.

Next, the content of the downloaded Web site is evaluated for known malware, known potential malware, or triggers that are often associated with malware. (Block 155) This evaluation process often involves searching the downloaded material for strings or coding techniques associated with malware. Assuming that it is determined that the downloaded content includes potential malware, then the Web page can be passed on for full evaluation, which begins at block 180.

Returning to the decision block 155, if the Web page does not include any known malware, potential malware, or triggers, then the “no” branch is followed to decision block 160. At block 160, the Web page—and potentially any linked Web pages—is statistically analyzed to determine if the probability that the Web page includes malware. For example, a Bayesian filter could be applied to the Web page and a score determined. Based on that score, a determination could be made that the Web page does not include malware, and the evaluation process could be terminated. (Block 170) Alternatively, the score could indicate a reasonable likelihood that the Web page includes malware, and the Web page could be passed on for further evaluation.

When a Web page requires further evaluation, active browsing (blocks 180 and 190) can be used. Initially, the Web page is loaded to a clean system and navigated, including populating forms and/or downloading programs in certain implementations. (Block 180) Any changes to the clean system caused by navigating the Web page are recorded. (Block 190). If these changes indicate the presence of malware, then the “yes” branch is followed and the statistical analysis engine is updated with data from the new Web page. (Block 200)

A malware definition can also be generated and pushed to the individual user. (Blocks 210 and 215). The definition can be based on the changes that the malware caused at the active browser 120. For example, if the malware made certain changes to the registry file, then those changes can be added to the definition for that malware program. Protected computers can then be told to look for this type of registry change. Text strings associated with offending JavaScript can also be stored in the definition. Similarly, applets, executable files, objects, and similar files can be added to the definitions. Any information collected can be used to update the statistical analysis engine. (Block 205.)

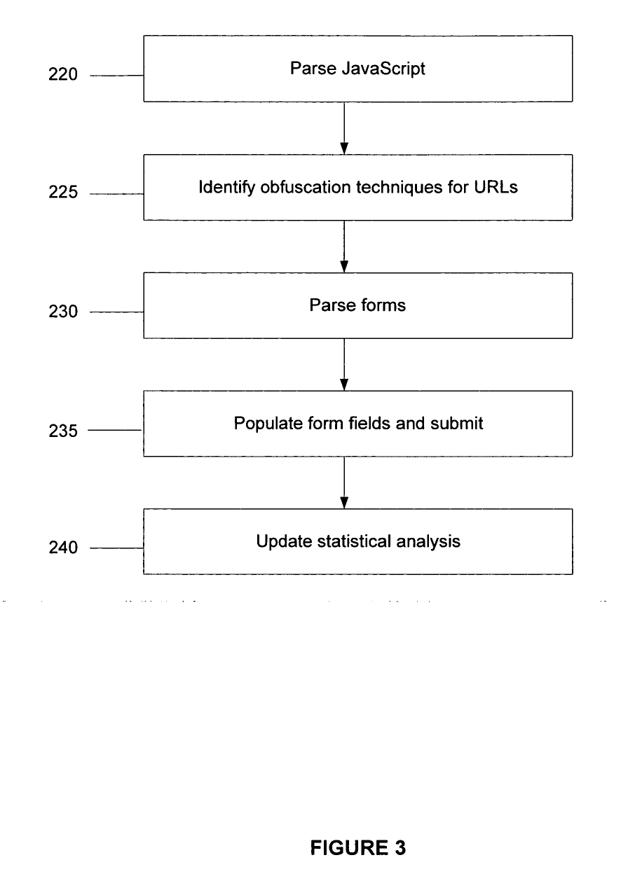

Referring now to FIG. 3, it is a flowchart of one method for parsing forms and JavaScript (and similar script languages) to identify malware. In this method, JavaScript embedded in downloaded material is parsed and searched for potential targets or links to potential targets. (Block 220) Because malware-related material, such as URLs and code, can be hidden within JavaScript, the JavaScript should either be interpreted with a JavaScript interpreter or otherwise searched for hidden data.

A typical JavaScript interpreter (also referred to as a “parser”) is MOZILLA provided by the Mozilla Foundation in Mountain View, Calif. To render the JavaScript, a parser interprets all of the code, including any code that is otherwise obfuscated. (Block 225) For example, JavaScript permits normal text to be represented in non-text formats such as ASCII and hexadecimal. In this non-textual format, searching for text strings or URLs related to potential malware is ineffective because the text strings and URLs have been obfuscated. But with the use of the JavaScript interpreter, these obfuscations are converted into a text-searchable format.

Any URLs that have been obfuscated can be identified as high priority and passed to the database for subsequent navigation. Similarly, when the JavaScript includes any obfuscated code, that code or the associated URL can be passed to the active browser 125 for evaluation. And as previously described, the active browser 125 can execute the code to see what changes it causes.

In another embodiment of the parser 115, when it comes across any forms that require a user to populate certain fields, then it passes the associated URL to the active browser 125, which can populate the fields and retrieve further information. (Blocks 230 and 235) And if the subsequent information causes changes to the active browser 125, then those changes would be recorded and possibly incorporated into a malware definition.

The Web page or material associated with the malware can be used to populate the statistical analysis engine 120. (Block 240) Similarly, when a Web page is determined not to include malware, that Web page can be provided to the statistical analysis engine 120 as an example of a good Web page.

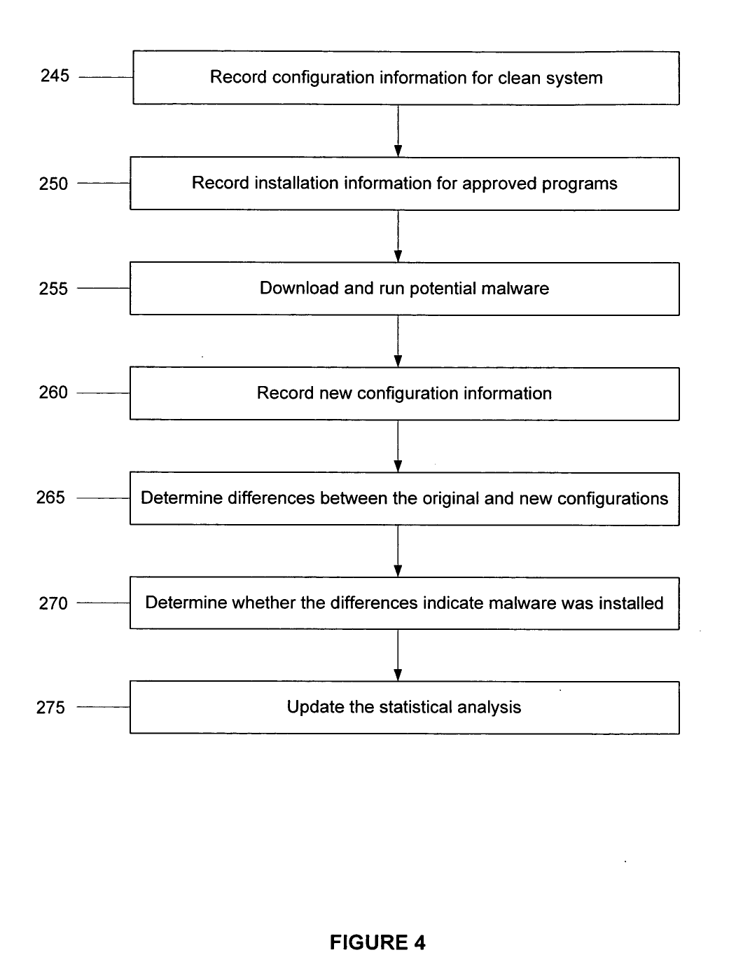

Referring now to FIG. 4, it is a flowchart of one method for actively browsing a Web site to identify potential malware. In this method, the active browser 125, or another clean computer system, is initially scanned and the configuration information recorded. (Block 245) For example, the initial scan could record the registry file data, installed files, programs in memory, browser setup, operating system (OS) setup, etc. Next, changes to the configuration information caused by installing approved programs can be identified and stored as part of the active-browser baseline. (Block 250) For example, the configuration changes caused by installing ADOBE ACROBAT could be identified and stored. And when the change information is aggregated together for each of the approved programs, the baseline for an approved system is generated.

The baseline for the clean system can be compared against changes caused by malware programs. For example, when the parser 115 passes a URL to the active browser 125, the active browser 125 browses the associated Web site as a person would. And consequently, any malware that would be installed on a user's computer is installed on the active browser 125. The identity of any installed programs would then be recorded.

After the potential malware has been installed or executed on the active browser 120, the active browser's behavior can be monitored. (Block 255) For example, outbound communications initiated by the installed malware can be monitored. Additionally, any changes to the configuration for the active browser 125 can be identified by comparing the system after installation against the records for the baseline system. (Blocks 260 and 265) The identified changes can then be used to evaluate whether a malware definition should be created for this activity. (Block 270) Again, shields could be used to evaluate the potential malware activity.

To avoid creating multiple malware definitions for the same malware, the identified changes to the active browser can be compared against changes made by previously tested programs. If the new changes match previous changes, then a definition should already be on file. Additionally, file names for newly downloaded malware can be compared against file names for previously detected malware. If the names match, then a definition should already be on file. And in yet another embodiment, a hash function value can be calculated for any newly downloaded malware file and it can be compared against the hash function value for known malware programs. If the hash function values match, then a definition should already be on file.

If the newly downloaded malware program is not linked with an existing malware definition, then a new definition is created. The changes to the active browser are generally associated with that definition. For example, the file names for any installed programs can be recorded in the definition. Similarly, any changes to the registry file can be recorded in the definition. And if any actual files were installed, the files and/or a corresponding hash function value for the file can be recorded in the definition. Any information collected during this process can also be used to update the statistical analysis engine. (Block 275)

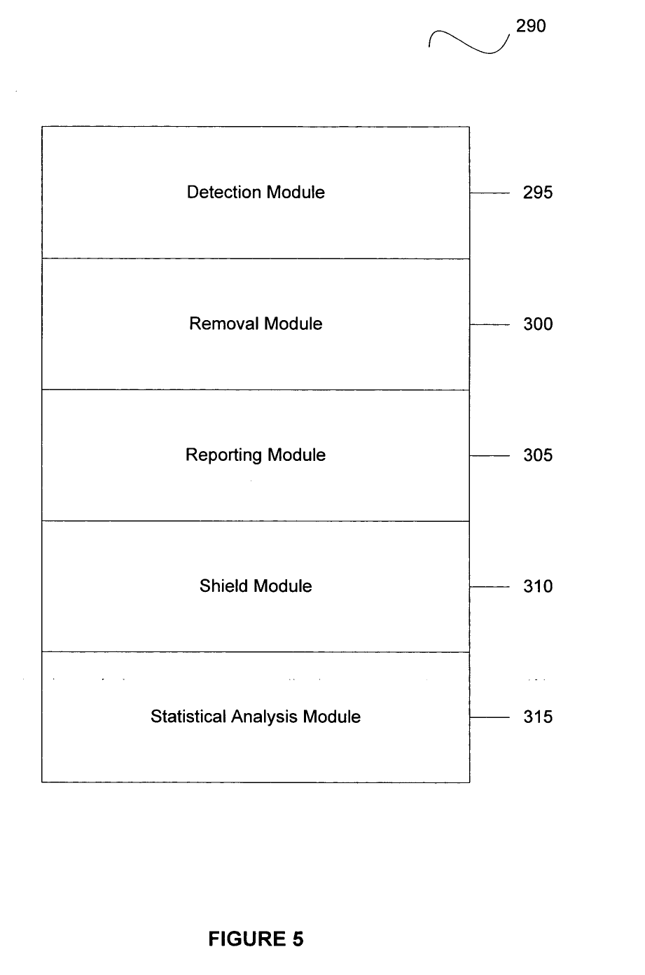

Referring now to FIG. 5, it illustrates a block diagram 290 of one implementation of the present invention. This implementation generally resides on the user's computer system (e.g., a protected computer system) as software and includes five components: a detection module 295, a removal module 300, a reporting module 305, a shield module 310, and a statistical analysis module 315. Each of these modules can be implemented in software or hardware and can be implemented together or individually. If implemented in software, the modules can be designed to operate on any type of computer system including WINDOWS and Linux-based systems. Additionally, the software can be configured to operate on personal computers and/or servers. For convenience, embodiments of the present invention are generally described herein with relation to WINDOWS-based systems. Those of skill in the art can easily adapt these implementations for other types of operating systems or computer systems.

Referring first to the detection module 295, it is responsible for detecting malware or malware activity on a protected computer. (The term “protected computer” is used to refer to any type of computer system, including personal computers, handheld computers, servers, firewalls, etc.) Typically, the detection module 295 uses malware definitions to scan the files that are stored on or running on a protected computer. The detection module 295 can also check WINDOWS registry files and similar locations for suspicious entries or activities. Further, the detection module 295 can check the hard drive for third-party cookies.

Note that the terms “registry” and “registry file” relate to any file for keeping such information as what hardware is attached, what system options have been selected, how computer memory is set up, and what application programs are to be present when the operating system is started. As used herein, these terms are not limited to WINDOWS and can be used on any operating system.

Malware and malware activity can also be identified by the shield module 310, which generally runs in the background on the protected computer. Shields, which will be discussed in more detail below, can generally be divided into two categories: those that use definitions to identify known malware and those that look for behavior common to malware. This combination of shield types acts to prevent known malware and unknown malware from running or being installed on a protected computer.

Once the detection or shield module (295 and 310) detects stored or running software that could be malware, the related files can be removed or at least quarantined on the protected computer. The removal module 300, in one implementation, quarantines a potential malware file and offers to remove it. In other embodiments, the removal module 300 can instruct the protected computer to remove the malware upon rebooting. And in yet other embodiments, the removal module 300 can inject code into malware that prevents it from restarting or being restarted.

In some cases, the detection and shield modules (295 and 310) detect malware by matching files on the protected computer with malware definitions, which are collected from a variety of sources. For example, host computers, protected computers and/or other systems can crawl the Web to actively identify malware. These systems often download Web page contents and programs to search for exploits. The operation of these exploits can then be monitored and used to create malware definitions.

Alternatively, users can report malware to a host computer (system 100 in FIG. 1 for example) using the reporting module 305. And in some implementations, users may report potential malware activity to the host computer. The host computer can then analyze these reports, request more information from the protected computer if necessary, and then form the corresponding malware definition. This definition can then be pushed from the host computer through a network to one or all of the protected computers and/or stored centrally. Alternatively, the protected computer can request that the definition be sent from the host computer for local storage.

This implementation of the present invention also includes a statistical analysis module 315 that is configured to determine the likelihood that Web pages, script, images, etc. include malware. Versions of this module are described with relation to the other figures.

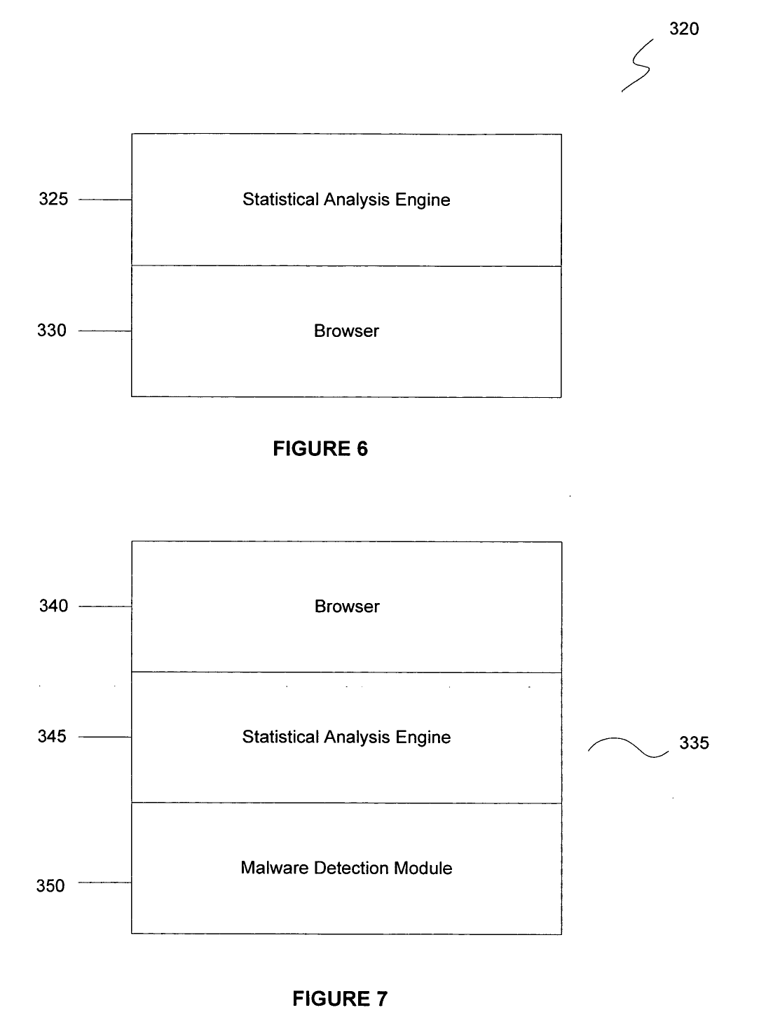

Referring now to FIG. 6, it is a block diagram of one implementation of a monitoring system 320. In this implementation, the statistical analysis engine 325 is incorporated with a Web browser 330. The statistical analysis engine 325 evaluates Web pages (or other data) for potential malware as the browser 330 retrieves them. And if the statistical analysis engine 325 determines that the Web page likely contains malware, then the user can be notified. Alternatively, the browser 330 could prevent the Web page from being fully loaded or could extract the potentially harmful sections of the Web page. In one embodiment, the user views a browser tool bar representing the statistical analysis engine 325.

One advantage of incorporating a statistical analysis engine 325 with the browser 330 is that the user can see the risks associated with each Web page as the Web page is being loaded onto the user's computer. The user can then block malware before it is installed or before it attempts to alter the user's computer. Moreover, the statistical analysis engine 325 generally relies on filtering technology, such as Bayesian filters or scoring filters, rather than malware definitions to evaluate Web pages. Thus, the statistical analysis engine 325 could recognize the latest malware or adaptation of existing malware before a corresponding definition is ever created.

Moreover, as the number of malware definitions grows, computers will require more time to analyze whether a particular script, program, or Web page corresponds to a definition. To prevent this type of performance drop, the statistical analysis engine 325 can operate separately from these malware definitions. And to provide maximum protection, the statistical analysis engine 325 can be operated in conjunction with a definition-based system.

If the statistical analysis engine 325 uses a learning filter such as a Bayesian filter, information from each Web page retrieved by the browser 330 can be used to update the filter. The filter could also receive updates from a remote system such as the system 100 shown in FIG. 1. And in yet another embodiment, the filter could exclusively receive its updates from a remote system.

FIG. 7 is a block diagram of another embodiment of a system 335 that could reside on a user's computer. This embodiment includes a browser 340, a statistical analysis engine 345, and a malware-detection module 350. The statistical analysis engine 345 supplements the malware-detection module 350. For example, the statistical analysis engine 340 could supplement the system illustrated in FIG. 5. In particular, the statistical analysis engine 340 could screen Web pages as they are browsed and possibly change the sensitivity settings within the shield module.

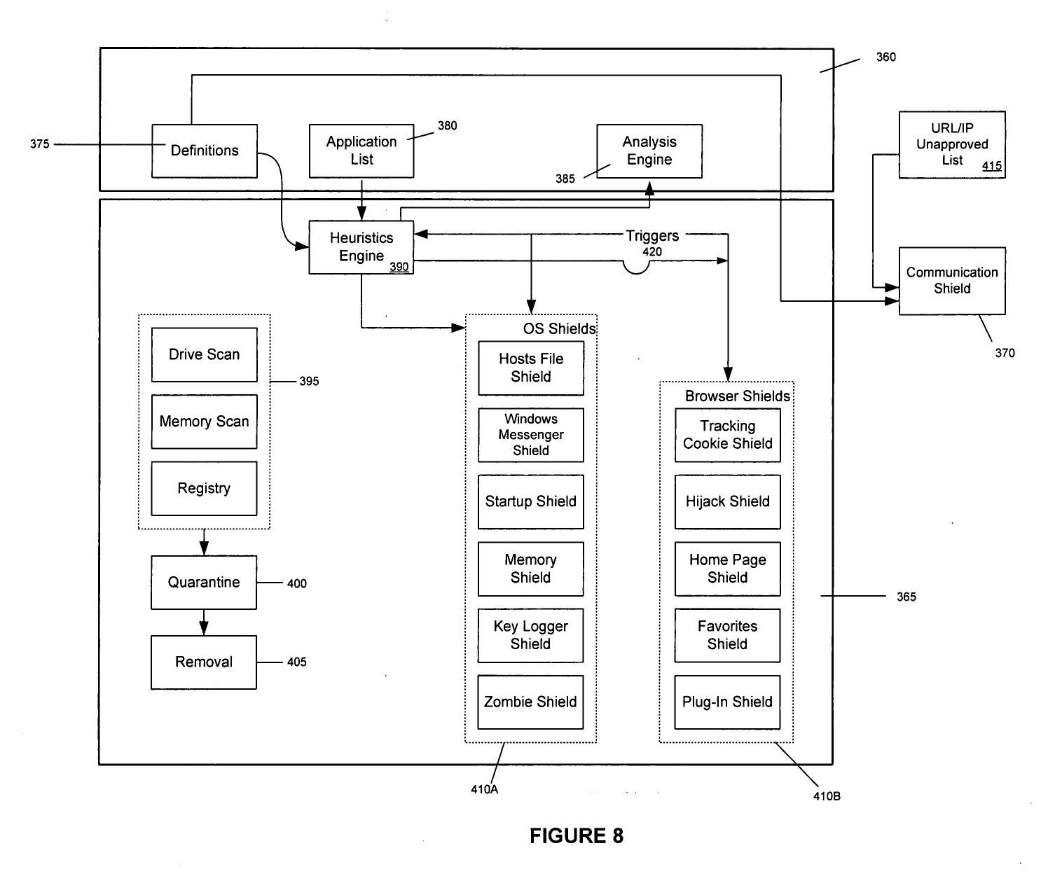

Referring now to FIG. 8, it illustrates another embodiment of the present invention. This figure illustrates the host system 360, the protected computer 365, and an enterprise-protection system 370. The enterprise-protection system 370 could also be used as an individual consumer product. And in these instances, the consumer could be operating a firewall or firewall-type application.

The host system 360 can be integrated onto a server-based system or arranged in some other known fashion. The host system 360 could include malware definitions 375, which include both definitions and characteristics common to malware. It can also include data used by the statistical analysis engine 120 (shown in FIG. 1). The host system 360 could also include a list of potentially acceptable malware. This list is referred to as an application approved list 380. Applications such as the GOOGLE toolbar and KAAZA could be included in this list. A copy of this list could also be placed on the protected computer 365 where it could be customized by the user. Additionally, the host system 360 could include a malware analysis engine 385 similar to the one shown in FIG. 1. This engine 385 could also be configured to receive snapshots of all or portions of a protected computer 365 and identify the activities being performed by malware. For example, the analysis engine 385 could receive a copy of the registry files for a protected computer that is running malware. Typically, the analysis engine 385 receives its information from the heuristics engine 390 located on the protected computer 365. Note that the heuristics engine 390 could also include a user-side statistical analysis engine. The heuristics engine 390 could provide data to the host system 375 that the host-side statistical analysis engine.

The malware-protection functions operating on the protected computer are represented by the sweep engine 395, the quarantine engine 400, the removal engine 405, the heuristic engine 390, and the shields 410. And in this implementation, the shields 410 are divided into the operating system shields 410A and the browser shields 410B. All of these engines can be implemented in a single software package or in multiple software packages.

The basic functions of the sweep, quarantine, and removal engines were discussed above. To repeat, however, these three engines compare files and registry entries on the protected computer against known malware definitions and characteristics. When a match is found, the filed is quarantined and removed.

The shields 410 are designed to watch for malware and for typical malware activity and includes two types of shields: behavior-monitoring shields and definition-based shields. In some implementations, these shields can also be grouped as operating-system shields 410A and browser shields 410B.

The browser shields 410B monitor a protected computer for certain types of activities that generally correspond to malware behavior. Once these activities are detected, the shield gives the user the option of terminating the activity or letting it go forward. The definition-based shields actually monitor for the installation or operation of known malware. These shields compare running programs, starting programs, and programs being installed against definitions for known malware. And if these shields identify known malware, the malware can be blocked or removed. Each of these shields is described below.

Favorites Shield—The favorites shield monitors for any changes to a browser's list of favorite Web sites. If an attempt to change the list is detected, the shield presents the user with the option to approve or terminate the action.

Browser-Hijack Shield—The browser-hijack shield monitors the WINDOWS registry file for changes to any default Web pages. For example, the browser-hijack shield could watch for changes to the default search page stored in the registry file. If an attempt to change the default search page is detected, the shield presents the user with the option to approve or terminate the action.

Host-File Shield—The host-file shield monitors the host file for changes to DNS addresses. For example, some malware will alter the address in the host file for yahoo.com to point to an ad site. Thus, when a user types in yahoo.com, the user will be redirected to the ad site instead of yahoo's home page. If an attempt to change the host file is detected, the shield presents the user with the option to approve or terminate the action.

Cookie Shield—The cookie shield monitors for third-party cookies being placed on the protected computer. These third-party cookies are generally the type of cookie that relay information about Web-surfing habits to an ad site. The cookie shield can automatically block third-party cookies or it can presents the user with the option to approve the cookie placement.

Homepage Shield—The homepage shield monitors the identification of a user's homepage. If an attempt to change that homepage is detected, the shield presents the user with the option to approve or terminate the action.

Common-ad-site Shield—This shield monitors for links to common ad sites, such as doubleclick.com, that are embedded in other Web pages. The shield compares these embedded links against a list of known ad sites. And if a match is found, then the shield replaces the link with a link to the local host or some other link. For example, this shield could modify the hosts files so that IP traffic that would normally go to the ad sites is redirected to the local machine. Generally, this replacement causes a broken link and the ad will not appear. But the main Web page, which was requested by the user, will appear normally.

Plug-in Shield—This shield monitors for the installation of plug-ins. For example, the plug-in shield looks for processes that attach to browsers and then communicate through the browser. Plug-in shields can monitor for the installation of any plug-in or can compare a plug-in to a malware definition. For example, this shield could monitor for the installation of INTERNET EXPLORER Browser Help Objects

Referring now to the operating system shields 410A, they include the zombie shield, the startup shield, and the WINDOWS-messenger shield. Each of these is described below.

Zombie shield—The zombie shield monitors for malware activity that indicates a protected computer is being used unknowingly to send out spam or email attacks. The zombie shield generally monitors for the sending of a threshold number of emails in a set period of time. For example, if ten emails are sent out in a minute, then the user could be notified and user approval required for further emails to go out. Similarly, if the user's address book is accesses a threshold number of times in a set period, then the user could be notified and any outgoing email blocked until the user gives approval. And in another implementation, the zombie shield can monitor for data communications when the system should otherwise be idle.

Startup shield—The startup shield monitors the run folder in the WINDOWS registry for the addition of any program. It can also monitor similar folders, including Run Once, Run OnceEX, and Run Services in WINDOWS-based systems. And those of skill in the art can recognize that this shield can monitor similar folders in Unix, Linux, and other types of systems. Regardless of the operating system, if an attempt to add a program to any of these folders or a similar folder, the shield presents the user with the option to approve or terminate the action.

WINDOWS-messenger shield—The WINDOWS-messenger shield watches for any attempts to turn on WINDOWS messenger. If an attempt to turn it on is detected, the shield presents the user with the option to approve or terminate the action.

Moving now to the definition-based shields, they include the installation shield, the memory shield, the communication shield, and the key-logger shield. And as previously mentioned, these shields compare programs against definitions of known malware to determine whether the program should be blocked.

Installation shield—The installation shield intercepts the CreateProcess operating system call that is used to start up any new process. This shield compares the process that is attempting to run against the definitions for known malware. And if a match is found, then the user is asked whether the process should be allowed to run. If the user blocks the process, steps can then be initiated to quarantine and remove the files associated with the process.

Memory shield—The memory shield is similar to the installation shield. The memory-shield scans through running processes matching each against the known definitions and notifies the user if there is a spy running. If a running process matches a definition, the user is notified and is given the option of performing a removal. This shield is particularly useful when malware is running in memory before any of the shields are started.

Communication shield—The communication shield 370 scans for and blocks traffic to and from IP addresses associated with a known malware site. The IP addresses for these sites can be stored on a URL/IP blacklist 415. And in an alternate embodiment, the communication shield can allow traffic to pass that originates from or is addressed to known good sites as indicated in an approved list. This shield can also scan packets for embedded IP addresses and determine whether those addresses are included on a blacklist or approved list.

The communication shield 370 can be installed directly on the protected computer, or it can be installed at a firewall, firewall appliance, switch, enterprise server, or router. In another implementation, the communication shield 370 checks for certain types of communications being transmitted to an outside IP address. For example, the shield may monitor for information that has been tagged as private. The communication shield could also include a statistical analysis engine configured to evaluate incoming and outgoing communications using, for example, a Bayesian analysis.

The communication shield 370 could also inspect packets that are coming in from an outside source to determine if they contain any malware traces. For example, this shield could collect packets as they are coming in and will compare them to known definitions before letting them through. The shield would then block any that are tracks associated with known malware.

To manage the timely delivery of packages, embodiments of the communication shield 370 can stage different communication checks. For example, the communication shield 370 could initially compare any traffic against known malware IP addresses or against known good IP addresses. Suspicious traffic could then be sent for further scanning and traffic from or to known malware sites could be blocked. At the next level, the suspicious traffic could be scanned for communication types such as WINDOWS messenger or IE Explorer. Depending upon a security level set by the user, certain types of traffic could be sent for further scanning, blocked, or allowed to pass. Traffic sent for further processing could then be scanned for content. For example, does the packet related to HTML pages, Javascript, active X objects, etc. Again, depending upon a security level set by the user, certain types of traffic could be sent for further scanning, blocked, or allowed to pass.

Key-logger shield—The key-logger shield monitors for malware that captures and reports out key strokes by comparing programs against definitions of known key-logger programs. The key-logger shield, in some implementations, can also monitor for applications that are logging keystrokes-independent of any malware definitions. In these types of systems, the shield stores a list of known good programs that can legitimately log keystrokes. And if any application not on this list is discovered logging keystrokes, it is targeted for shut down and removal. Similarly, any key-logging application that is discovered through the definition process is targeted for shut down and removal. The key-logger shield could be incorporated into other shields and does not need to be a stand-alone shield.

Still referring to FIG. 8, the heuristics engine 390 blocks repeat activity and can also notify the host system 365 about reoccurring malware. Generally, the heuristics engine 390 is tripped by one of the shields (shown as trigger 420). Stated differently, the shields report any suspicious activity to the heuristics engine 390. If the same activity is reported repeatedly, that activity can be automatically blocked or automatically permitted—depending upon the user's preference. The heuristics engine 390 can also present the user with the option to block or allow an activity. For example, the activity could be allowed once, always, or never.

In other embodiments, the heuristics engine 390 can include a statistical analysis engine similar to the one described with relation to FIGS. 6 and 7.

And in some implementations, any blocked activity can be reported to the host system 360 and in particular to the analysis engine 385. The analysis engine 385 can use this information to form a new malware definition or to mark characteristics of certain malware. Additionally, or alternatively in certain embodiment, the analysis engine 385 can use the information to update the statistical analysis engine that could be included in the analysis engine 385.

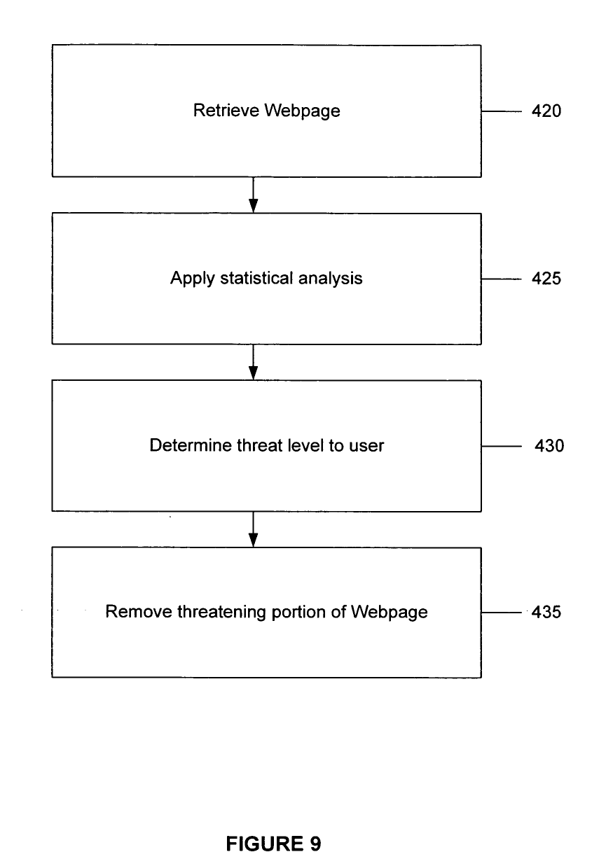

Referring now to FIG. 9, it is a flowchart of one method for screening Web pages as they are downloaded to a browser. In this method, a user or a program running on the user's computer initially requests a Web page. Although this flow chart focuses on Web pages, the method also works for any type of downloaded material including programs and data files.

Once the user requests the Web page, the browser formulates its requests and sends it to the appropriate server. (Block 420) This process is well known and not described further. The server then returns the requested Web page to the browser. But before the browser displays the Web page, the content of the Web page is subjected to a statistical analysis such as a Bayesian analysis. (Block 425) This analysis generally returns a score for the Web page, and that score can be used to determine the likelihood that the Web page includes malware. (Block 430) For example, the score for a Web page could be between 1 and 100. If the score is over 50, then the user could be cautioned that malware could possibly exist. And if the score is over 90, then the browser could warn the user that malware very likely exists in the downloaded page. The browser could also give the user the option to prevent this Web page from fully loading and/or to block the Web page from performing any actions on the user's computer. For example, the user could elect to prevent any scripts on the page from executing or to prevent the Web page from downloading any material or to prevent the Web page from altering the user's computer. And in another embodiment, the browser could be configured to remove and/or block the threatening portions of a Web page and to display the remaining portions for the user. (Block 435) The user could then be given an option to load the removed or blocked portions.

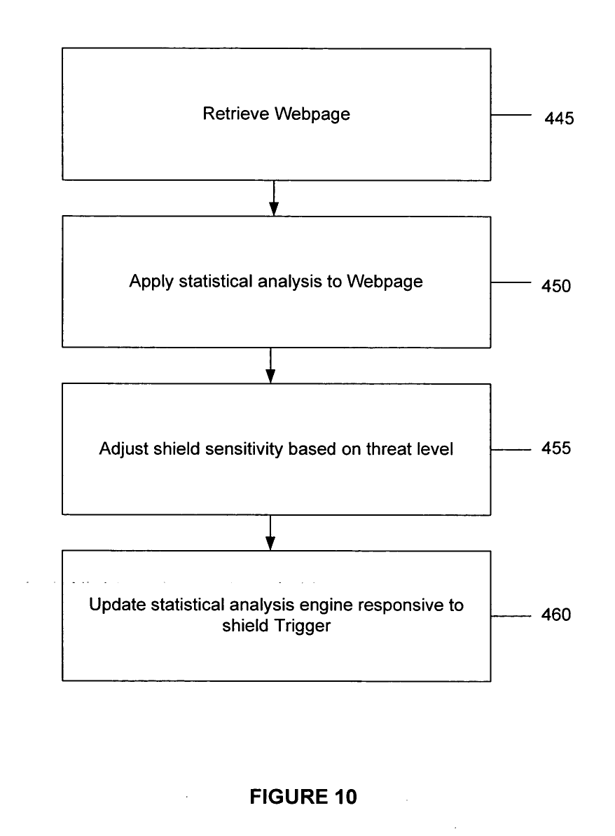

Referring now to FIG. 10, it is a block diagram illustrating one method of using a statistical analysis in conjunction with malware detection programs. This method generally operates on a user's computer and is initiated by a user or a program on the user's computer requesting a Web page. (Block 445) Again, this method is not limited to Web pages. As the Web page is being downloaded or once the Web page is downloaded, its content can be analyzed using a statistical analysis such as a Bayesian analysis—although several other methods will also work. (Block 450) The statistical analysis of the Web page will generally return a score that can be translated into a threat level. This score and/or threat level can be used to adjust the sensitivity level of the OS shields (element 410A in FIG. 8), the sensitivity level of the browser shields (element 410B in FIG. 8), and/or the sensitivity level of other portions of malware detection software installed on the user's computer or a firewall. (Block 455) And in some cases, information collected during the statistical analysis can be fed back into the analysis engine to improve the analysis process. (Block 460)

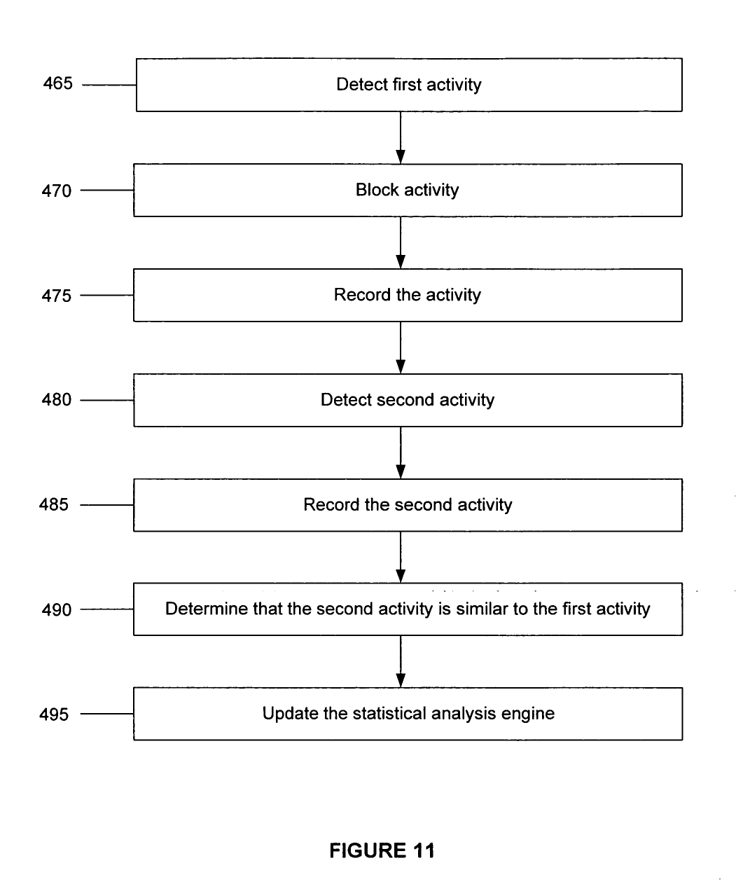

Referring now to FIG. 11, it is another method for managing malware that is resistant to permanent removal or that cannot be identified for removal. In this implementation, malware activity is identified. (Block 465) The activity could be identified by the presence of a certain file or by activities on the computer such as changing registry entries. If a malware program can be identified, then it should be removed. If the program cannot be identified, then the activity can be blocked. (Block 470) In essence, the symptoms of the malware can be treated without identifying the cause. For example, if an unknown malware program is attempting to change the protected computer's registry file, then that activity can be blocked. Both the malware activity and the countermeasures can be recorded for subsequent diagnosis. (Block 475)

Next, the protected computer detects further malware activity and determines whether it is new activity or similar to previous activity that was blocked. (Blocks 480, 485, and 490) For example, the protected computer can compare the malware activity—the symptoms—corresponding to the new malware activity with the malware activity previously blocked. If the activities match, then the new malware activity can be automatically blocked. (Block 490) And if the file associated with the activity can be identified, it can be automatically removed. Finally, any information collected about the potential malware can be passed to the statistical analysis engine on the user's computer to update the statistical analysis process. (Block 495) Similarly, the collected information could be passed to the host computer (element 360 in FIG. 8).

In conclusion, the present invention provides, among other things, a system and method for managing, detecting, and/or removing malware. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for generating a definition for malware, the method comprising:
receiving a URL corresponding to a Web site that includes content;
downloading at least a portion of the content from the Web site, determining the likelihood that the downloaded content includes malware;
responsive to the determined likelihood surpassing a threshold value, passing at least a portion of the potential malware to an active browser, the active browser having a known configuration;
operating the potential malware on the active browser;
recording changes to the known configuration of the active browser, wherein the changes are caused by operating the potential malware;
determining whether the recorded changes to the known configuration are indicative of malware; and
responsive to determining that the recorded changes are indicative of malware, generating a definition for the potential malware.

2. The method of claim 1, further comprising:
parsing the downloaded content to identify known malware or a known malware indicator.

3. The method of claim 2, wherein parsing the downloaded content comprises:
identifying an obfuscated URL in the downloaded content.

4. The method of claim 3, wherein identifying an obfuscated URL in the downloaded content comprises:
identifying a URL encoded in ASCII.

5. The method of claim 3, wherein identifying an obfuscated URL in the downloaded content comprises:
identifying a URL encoded in hexadecimal.

6. The method of claim 2, wherein parsing the downloaded content to identify the potential malware comprises:
parsing script included in the content.

7. The method of claim 6, wherein parsing the downloaded content to identify the potential malware comprises:
parsing the script to identify an obfuscated URL.

8. The method of claim 1, wherein determining the likelihood that the downloaded content includes malware comprises:
applying a statistical analysis to the downloaded content.

9. The method of claim 8, wherein the downloaded content includes HTML and format instructions and wherein applying the statistical analysis comprises:
evaluating the HTML and the format instructions using the statistical analysis.

10. The method of claim 1, wherein determining the likelihood that the downloaded content includes malware comprises:
applying a Bayesian analysis to the downloaded content.

11. The method of claim 1, wherein determining the likelihood that the downloaded content includes malware comprises:
applying a scoring analysis to the downloaded content.

12. The method of claim 11, further comprising:
updating the scoring analysis responsive to determining that the recorded changes to the known configuration are indicative of malware.

13. The method of claim 12, further comprising:
updating the scoring analysis responsive to determining that the recorded changes to the known configuration are not indicative of malware.

14. A system for generating a definition for malware, the system comprising:
a downloader for downloading a portion of a Web site,
a parser for parsing the downloaded portion of the Web site;
a statistical analysis engine for determining if the downloaded portions of the Web site should be evaluated by the active browser;
an active browser for identifying changes to the known configuration of the active browser, wherein the changes are caused by the downloaded portion of the Web site; and
a definition module for generating a definition for the potential malware based on the changes to the known configuration.

15. The system of claim 14, wherein the parser comprises an HTML parser.

16. The system of claim 14, wherein the parser comprises a script parser.

17. The system of claim 16, wherein the script parser comprises:
a JavaScript parser.

18. The system of claim 14, wherein the parser comprises a form parser.

19. The system of claim 14, wherein the active browser comprises:
a plurality of shield modules.

20. The method of claim 14, wherein determining the likelihood that the downloaded content includes malware comprises:
a content-scoring filter.

21. The method of claim 14, wherein determining the likelihood that the downloaded content includes malware comprises:
a self-learning content-scoring filter.

22. The method of claim 14, wherein determining the likelihood that the downloaded content includes malware comprises:
a Bayesian scoring filter.
